(19) United States
(12) Patent Application Publication
(10) Pub. No.: US 2025/0103952 A1
(43) Pub. Date: Mar. 27, 2025

(54) FEDERATED LARGE MODEL ADAPTIVE LEARNING SYSTEM

(71) Applicants: Hebei University of Technology, Tianjin (CN); Zhejiang Lab, Hangzhou (CN); Shenzhen Institute for Advanced Study, University of Electronic Science and Technology of China, Shenzhen (CN); DALIAN UNIVERSITY OF TECHNOLOGY, Dalian (CN)

(72) Inventors: Bin CAO, Tianjin (CN); Zeyu JIANG, Tianjin (CN); Xin LIU, Tianjin (CN); Wen CHENG, Tianjin (CN); Yun LI, Tianjin (CN); Rensheng SHEN, Tianjin (CN); Yuchun CHANG, Tianjin (CN)

(21) Appl. No.: 18/521,883

(22) Filed: Nov. 28, 2023

(30) Foreign Application Priority Data
Sep. 25, 2023 (CN) 202311238148.4

(51) Int. Cl. G06N 20/00

(52) U.S. Cl. CPC G06N 20/00

(57) ABSTRACT

The present invention provides a federated large model adaptive learning system. Based on the combination of multiobjective optimization and incremental learning, multiple optimization indexes are constructed, and adaptive mini model incremental learning is designed. A gradient scaling method of mini models is proposed for data privacy protection under federated learning, to make full use of gradient information. A correlation between the generalization ability and sampling data is revealed to propose a generalization ability evaluation function. With respect to the real problems of performance degradation and fault faced by industrial equipment during operation, multiple optimization objectives are designed in combination with the generalization ability evaluation function, and the models are updated and repaired adaptively through multiobjective evolutionary learning, to improve the usability of large models in real industrial scenarios. Finally, the adaptive accurate update of the large models and mini models is realized to improve the generalization ability of the models.

### TECHNICAL FIELD

The present invention relates to federated learning, evolutionary algorithms and adaptive intelligent algorithms, and in particular to a federated large model adaptive learning system.

### BACKGROUND

It is difficult for many companies to share big data directly because of reasons such as confidentiality of industry data. Under this need, federated learning with privacy protection ability is highly valued by domestic and foreign scholars. Qiang Yang has proposed secure federated learning in “Federated Learning with Privacy-preserving and Model IP-right protection”, and used the encryption technology to protect data to ensure the security protection of the data during transmission and storage. Guoyi Shi has reviewed privacy protection research in the federated learning framework in detail and explored the advantages and disadvantages of the existing privacy protection technologies and potential solutions in “Privacy preservation in federated learning: An insightful survey from the GDPR perspective”. Bin Cao has proposed many federated learning algorithms and their evolutionary strategies in “Federated neural architecture search for medical data security”. WeifengLv has designed a cross-platform federated learning framework for order scheduling in “Fed-LTD: Towards Cross-Platform Ride Hailing via Federated Learning to Dispatch”, i.e., a plurality of platforms collaborate to make scheduling decisions without sharing their local data, to explore the challenges of privacy and efficiency.

In another aspect, degradation of equipment performance, such as aging and fault, may lead to the failure of AI models, which needs to design adaptive intelligent algorithms. The research of the adaptive intelligent algorithms has appeared. In the field of evolutionary computation, Yun Li et al. have proposed an adaptive evolutionary algorithm in “Adaptive particle swarm optimization” to automatically control algorithm parameters in the evolutionary process. In the field of adaptive deep learning, Yining Dong has proposed a deep dynamic adaptive transfer network in “Deep dynamic adaptive transfer network for rolling bearing fault diagnosis with considering cross-machine instance”, which realizes dynamic adaptive model update. Islam has proposed an automatic machine learning co-exploration framework EVE in “EVE: Environmental Adaptive Neural Network Models for Low-power Energy Harvesting System”, which adaptively selects candidate models.

There is slightly less work that combines federated learning with adaptive and evolutionary ideas. Bin Cao has proposed a heterogeneous large-scale multiobjective federated neuroevolutionary strategy based on a new idea in combination with federated learning and evolutionary ideas in “Large-Scale Multiobjective Federated Neuroevolution for Privacy and Security in the Internet of Things”. Chunhua Xiao has proposed a sparse network model evolutionary algorithm for federated learning in “CBFL: A Communication-Efficient Federated Learning Framework From Data Redundancy Perspective”. Zehui Zhang has proposed an adaptive model aggregation solution for federated learning in “an adaptive federated deep learning algorithm for non-independent identically distributed data”.

With respect to the problem that it is difficult to combine the federated learning algorithm, the evolutionary algorithm and the adaptive intelligent algorithm, the present invention forms a unified federated large model adaptive learning system by sorting out the relationship among the three and combining them organically. The present invention analyzes the task characteristics of large and mini models to design multiple optimization objectives, such as generalization ability, model accuracy, etc. respectively, combines the evolutionary ideas with the adaptive intelligent algorithms; and designs a gradient scaling method to further unify the federated learning, the evolutionary ideas and the adaptive intelligent algorithms to form the federated large model adaptive learning system.

### SUMMARY

The purpose of the present invention is to construct a federated large model adaptive learning system, which generates an AI model on the premise of reducing the risk of data privacy leakage, and achieves the accurate adaptive update of the AI model through a small amount of the latest data. The contents of the present invention comprise: constructing an adaptive mini model for incremental learning; proposing a gradient scaling method for data privacy protection under federated learning; revealing a correlation between the generalization ability of the model and training data, and proposing a generalization ability evaluation function; designing multiple optimization objectives, updating and repairing the model adaptively through multiobjective evolutionary learning, and improving the usability of a large model.

The technical solution of the present invention is as follows:

A federated large model adaptive learning system can be widely applied to many pre-training large models, such as BERT, ChatGPT, etc., and has the functional properties of effectively improving the universality, functionality and high efficiency of the pre-training large models. The federated adaptive learning system is mainly composed of a mini model adaptive update module, a BERT large model and mini model normalization module, a BERT large model adaptive update module and a system privacy protection module; and the process of applying the federated adaptive learning system to the pre-training large models will be described successively in the order of each module (taking BERT as an example, but the applying object of the learning system is not limited to BERT).

### (1) Mini Model Adaptive Update Module

For the problem of difficulty in interaction between BERT large models and mini models, the mini model adaptive update module is designed. Through the adaptive update of the mini models, the performance of the BERT large models can be improved, e.g., improving model accuracy and reducing calculation overhead. Considering three optimization directions of mini model accuracy, mini model forgetting rate and mini model error, the mini model adaptive update module establishes adaptive criteria through the above optimization directions:

### 1) Mini Model Accuracy:

From the perspective of universality, in the mini model adaptive update, the accuracy of the mini models will determine the universality of the BERT large models. Therefore, a mini model accuracy submodule is proposed, expressed as follows:

$$max {C}_{m} = \frac{1}{m} {\sum }_{i = 1}^{m} {t}_{i}$$

wherein Cₘ represents the average accuracy value of the mini model after an m incremental stage, and tᵢ represents the accuracy value corresponding to an i stage.

### 2) Mini Model Forgetting Rate:

From the perspective of functionality, in the mini model adaptive update, the mini model forgetting rate determines the convergence property of the mini models, and further determines the convergence of the BERT large models. Therefore, the mini model forgetting rate submodule is designed, expressed as follows:

$$min F ( q ) = ud + ( 1 - u ) F ( q - 1 )$$

wherein F(q) represents the mini model forgetting rate of the mini model at time q; F(q) represents the mini model forgetting rate of the mini model at time q−1; u is a coefficient with a value range between [0,1], which is used to control a decay rate; and d is data at current time.

### 3) Mini Model Error Gradient:

From the perspective of high efficiency, in the mini model adaptive update, the error gradient directly determines the efficiency of the BERT models. Therefore, a mini model error gradient submodule is designed, expressed as follows:

$$min w ( v ) = w ( v - 1 ) + η \times ∇ E ( v )$$

wherein w(v) represents the weight at time v, w(v−1) represents the weight at time v−1, η is a learning rate, and ∇E(v) represents the error gradient at time v;

### (2) BERT Large Model and Mini Model Normalization Module

In the process of the mini model adaptive update, mini model gradient information is generated continuously. Therefore, the BERT large model and mini model normalization module will realize normalization of the BERT large modules and the mini models in the gradient information to establish a basis for the implementation of the BERT large model adaptive update module. The gradient information has two properties of size and direction. The privacy protection principle of federated learning allows the mini models to transmit the gradient information to the BERT large models, and the gradient information generated by the mini models is used for feedback learning of the BERT large models. However, there is a huge difference in the number of parameters between the large BERT models and the mini models, and the gradient of the mini models cannot be directly used by the BERT large models. Therefore, a method based on gradient scaling is proposed to assess the difference in the number of parameters between the mini models and the BERT large models and priori knowledge, so as to establish the corresponding relationship between the gradient values of the mini models and the gradient values of the BERT large models. The gradient scaling method is expressed as follows:

$${T}_{grad}^{′} = {t}_{grad}^{′} ( \frac{{T}_{grad}}{2 {t}_{grad}} + \frac{{T}_{n}}{2 {t}_{n}} )$$

wherein T_{grad′} represents the corresponding gradient value of the mini models on the large models, t_{grad′} represents the gradient value of the mini models, T_{rad} is the priori gradient value of the large models, t_{grad} is the priori gradient value of the mini models, Tₙ is the number of parameters of the large models, and tₙ is the number of parameters of the mini models.

### (3) BERT Large Model Adaptive Update Module

In the BERT large model and mini model normalization module, the normalization of the mini model gradient information and the BERT large model gradient information is realized. The BERT large model adaptive update module determines the gradient information normalization from two aspects of the generalization ability and gradient fitting to help the BERT large models for adaptive update.

### 1) Generalization Ability

In order to monitor the gap of the learning direction between the BERT large models and mini models, the consistency of collaborative learning directions between the BERT large models and mini models is maintained; through a distributed perception method, the local data is firstly used for measuring the deviation value of the large models preliminarily, and then making secondary measurement in combination with the online data at an edge server. Therefore, a generalization assessment method is proposed for assisting the adaptive learning function of the federated adaptive learning system, expressed as follows:

$$f ( x , y ) = \frac{1}{( 1 + {e}^{- \vert g ( x , y ) \vert} )} \\ g ( x , y ) = \frac{α ( 2 {μ}_{x} {μ}_{y} + {δ}_{1} ) ( 2 {σ}_{x , y} + {δ}_{2} )}{( {μ}_{x}^{2} + {μ}_{y}^{2} + {δ}_{1} ) ( {σ}_{x}^{2} + {σ}_{y}^{2} + {δ}_{2} )} - λ$$

wherein f(x,y) is called a generalization evaluation function, and g(x,y) is called a distributed perceived similarity function; x and y are the evaluation results of the large models and the mini models respectively; x and y are one-dimensional vectors; μₓ and μ_{y} dare the average values of the two respectively; σₓ and σ_{y} are the variances of the two respectively; and a, are the covariances of the two; δ₁ and δ₂ are two minimal constants respectively, to prevent σ_{x,y} denominator from being 0; α is a scaling factor with a value range of [10,20] to ensure that the range of f(x,y) is between (0,1); λ is a normalization constant which limits the range of the domain of definition;

Through the generalization assessment method, the generalization ability is expressed as follows:

$$max {\sum }_{i = 0}^{n} {f}_{i} ( x , y ) \\ s . t . \frac{1}{n + 1} {\sum }_{k = 0}^{n} {\sum }_{j = 0}^{n} \vert {f}_{k} ( x , y ) - {f}_{j} ( x , y ) \vert \leq C$$

wherein fᵢ(x,y) is a generalization ability value in different tasks; n is the number of the tasks; C is a constant having a value between [0,1], and C constrains the differences in the assessment of the generalization ability among different tasks;

### 2) Gradient Fitting

Because the BERT large model cannot obtain the latest data, starting from gradient information, the gradient of the BERT large model is fitted with the mini model as much as possible, to indirectly learn the features of the latest data. The gradient fitting is expressed as follows:

$$min {\sum }_{i = 0}^{S} \vert {T}_{i} - {t}_{i} \vert$$

wherein Tᵢ is the gradient value of the large model, tᵢ is the gradient value of the mini model, and S is the maximum number of training;

### (4) System Privacy Protection Module

In the mini model adaptive update module, the BERT large model and mini model normalization module and the BERT large model adaptive update module, the federated adaptive learning system is applied to the BERT large model. The system privacy protection module is combined in the federated adaptive learning system, and the federated adaptive learning system is placed in a privacy protection mechanism. The system privacy protection module realizes the privacy protection of the federated adaptive learning system, comprising a noise adding mechanism and an approximate weight matrix average vale mechanism.

### 1) Noise Adding Mechanism

With respect to the characteristic that the interactive learning process of the BERT large models and mini models is private, the noise adding mechanism is proposed to hide the contribution of a single client in the aggregation by a method of adding after subsampling to hide in the entire distributed learning process. The specific implementation is as follows:

In random subsampling, the total number of clients is denoted as K; in each round of communication, a random subset Zₜ with a size T is extracted, and a subscript t represents the number of current rounds; then an administrator distributes a central model of the current round to each client; the central model of the current round is denoted as Wₜ; the data of the central model is optimized by a customer; each independent client in Zₜ has a different client model {W^{k}}ₖ₌₀^{T}; and Gaussian noise operation is added to each client:

$${\overline{W}}^{k} = {W}^{k} + N ( 0 , {σ}^{2} ) k ∈ [ 0 , T ]$$

wherein W̅^{k} is the client model after Gaussian noise is added, the noise follows N(0,σ²) distribution, and a standard deviation σ determines a noise scale; and a difference between the optimized client model W̅^{k} and the central model Wₜ is called the update of the client model and denoted as ΔW̅^{k};

At the end of each round of communication t, the update ΔW̅^{k} of the clients is transmitted back to the administrator of the central model;

### 2) Approximate Weight Matrix Average Vale Mechanism

With respect to the characteristic that the interactive learning process of the BERT large models and mini models is complicated, a method for approximating the average value of the weight matrix by distorting the sum of all updates by a Gaussian mechanism is proposed. The method uses the Gaussian mechanism to distort the sum of all the updates, and enhances certain operational sensitivity by using scaling versions instead of real updates. The specific implementation is as follows:

$$Δ {{W}^{=}}^{k} = Δ {\overline{W}}^{k} / max ( 1 , \frac{{‖ Δ {\overline{W}}^{k} ‖}_{2}}{S} )$$

wherein ΔW̅^{k} represents the scaling of the update model after scaling, and S represents scaling sensitivity;
S is added to the sum of all scaling updates and then the output of the mixed noise mechanism is divided by T to obtain the real average value of the updates of all clients while preventing the disclosure of critical personal information; and the approximate value is added to Laplace noise and added to the current central model Wₜ to distribute a new central model:

$${W}_{t + 1} = {W}_{t} + \frac{1}{T} ( {\sum }_{k = 0}^{T} Δ {{W}^{=}}^{k} + {\sum }_{k = 0}^{T} Laplace ( \frac{Δ {\overline{W}}^{k}}{ε} ) )$$

wherein Laplace represents Laplace noise calculation and ε represents privacy budget.

The present invention has the beneficial effects that: the present invention takes model accuracy, a learning forgetting rate and error gradient as optimization objectives, and forms a multiobjective optimization incremental learning method. The corresponding relationship between the gradient values of the large models and the mini models is established through the gradient scaling method by using a federated learning privacy protection principle, and the gradient information generated by the mini models is transmitted back to the large models for learning to maintain collaborative learning of the large models and the mini models. The distributed perception method is introduced to monitor the learning direction gap of the large models and the mini models, and a multiobjective evolutionary algorithm is formed by combining the gradient fitting optimization objective, the generalization ability optimization objective and the model accuracy optimization objective so that the large models can be updated adaptively and the generalization ability of the large models is greatly improved.

### DESCRIPTION OF DRAWINGS

FIG. 1 is a schematic diagram of a method of the present invention.

FIG. 2 shows a mini model adaptive update module.

FIG. 3 shows a BERT large model and mini model normalization module.

FIG. 4 shows a privacy protection module.

FIG. 5 shows a BERT large model adaptive update module.

### DETAILED DESCRIPTION

The embodiments of the present invention are further described below in combination with the drawings of the description and the specific technical solution. (taking BERT as an example, but the applying object of the learning system is not limited to BERT).

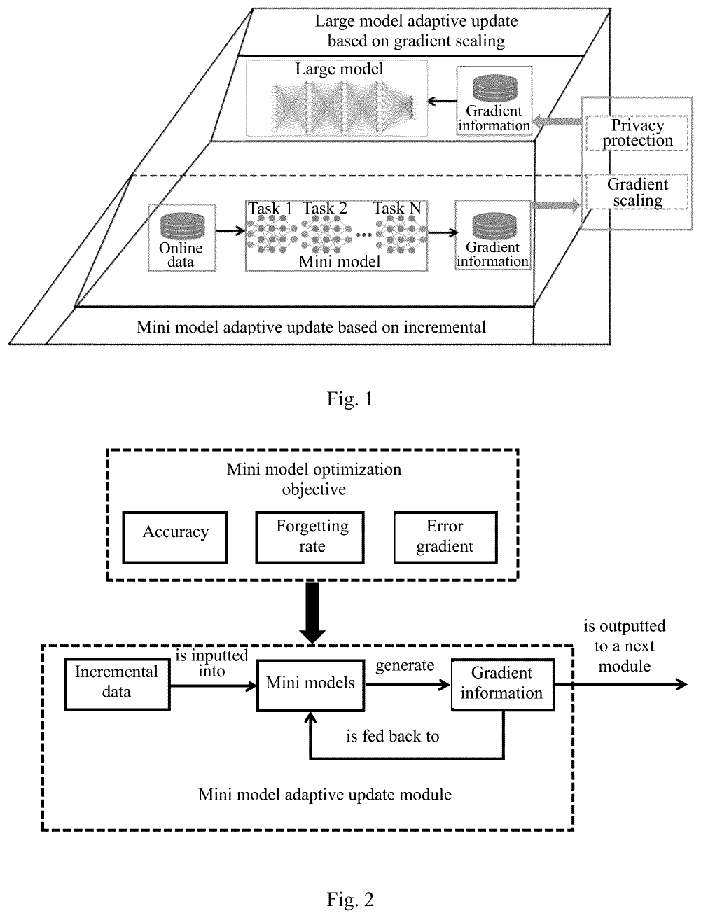

Referring to FIG. 1, the federated large model adaptive learning system provided by the present invention firstly updates the mini models of incremental learning adaptively by using online data, then conducts gradient scaling and privacy protection for the gradient information obtained by the mini models, and finally updates the large models adaptively by using the gradient information.

### 1. Adaptive Update of Mini Models

Referring to FIG. 2, in the mini model adaptive update module, the adaptive direction is determined by three directions: the mini model accuracy, the forgetting rate of the mini models and the error gradient. When new data is added, incremental learning only adaptively updates the gradient parameter information generated by the added data, so that the latest data can be learned at a small cost.

### 2. Gradient Scaling and Privacy Protection of Gradient Information

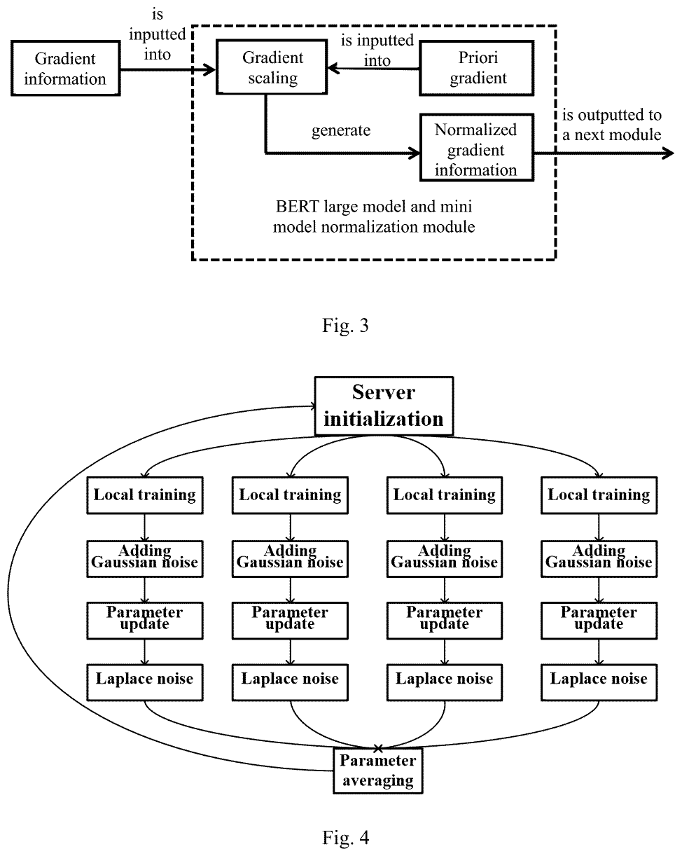

As shown in FIG. 3, the gradient information is generated by the mini models in the incremental learning process based on multiobjective evolution. Therefore, the gradient information of BERT large models and mini models is normalized by the gradient scaling method, so that the BERT large models can use the gradient information generated by the mini models for feedback learning.

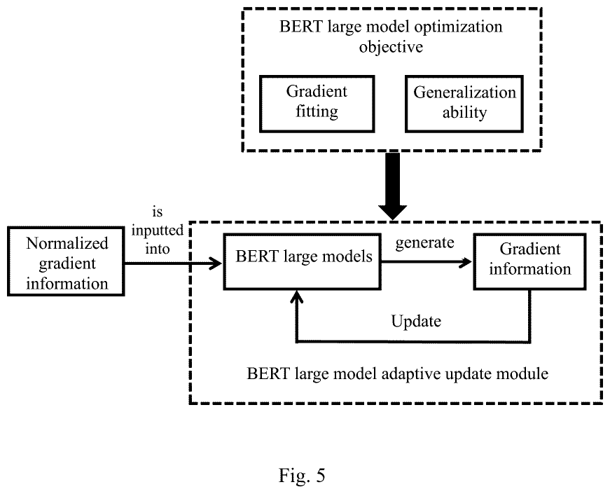

Referring to FIG. 4, considering the privacy protection principle, the gradient information generated by the mini models shall be encrypted. The present invention proposes a differential privacy algorithm based on a mixed noise mechanism, which comprises two steps of adding noise after random subsampling parameters are updated and using a Gaussian mechanism to distort the sum of all updates, thereby embedding the privacy protection process into the process of distributed learning.

### 3. BERT Large Model Adaptive Update Based on Gradient Scaling

Referring to FIG. 5, from two aspects of the gradient information and the generalization ability, the gradient fitting optimization objective and the generalization ability optimization objective are designed respectively.

Gradient fitting optimization objective:

$$min {\sum }_{i = 0}^{S} \vert {T}_{i} - {t}_{i} \vert$$

wherein Tᵢ is the gradient value of the BERT large model, tᵢ is the gradient value of the mini model, and S is the maximum number of training.

A series of tasks are created for the mini models, comprising classification and regression, and the loss function is changed to obtain dozens of tasks. The generalization ability of the mini models under different tasks can be assessed independently, so as to obtain the corresponding generalization ability value. According to the proposed adaptive collaborative control function, the generalization ability optimization objective can be obtained by taking the above dozens of index values as collaborative variables.

Generalization ability optimization objective:

$$max {\sum }_{i = 0}^{n} {f}_{i} ( x , y ) \\ s . t . \frac{1}{n + 1} {\sum }_{k = 0}^{n} {\sum }_{j = 0}^{n} \vert {f}_{k} ( x , y ) - {f}_{j} ( x , y ) \vert \leq C$$

wherein fᵢ(x,y) is a generalization ability value in different tasks; n is the number of the tasks; C is a constant having a value between [0,1], and C constrains the differences in the assessment of the generalization ability among different tasks, to obtain more accurate optimization results.

TABLE 1
Classification Accuracy of BERT and Federated
Adaptive BERT on Different Data Sets

Network Model

| | | Federated Adaptive |
|---|---|---|
| Data Sets | BERT | BERT |
| IMDB | 0.768 | 0.773 |
| GLUE | 0.801 | 0.805 |

Higher classification accuracy indicates better performance of the large models in the classification tasks, which can help to assess the classification ability of the large models for different types of samples. As shown in Table 1, benefited from the gradient fitting optimization objective and the generalization ability optimization objective, the classification accuracy of BERT under the federated large model adaptive learning system in two data sets is significantly improved compared with the BERT original model.

TABLE 2
Classification Recall of BERT and Federated
Adaptive BERT on Different Data Sets

Network Model

| | | Federated Adaptive |
|---|---|---|
| Data Sets | BERT | BERT |
| IMDB | 0.752 | 0.757 |
| GLUE | 0.783 | 0.791 |

Considering that there may be an imbalance problem of types in the data sets, it is necessary to measure the recall of the models. As shown in Table 2, the classification recall of BERT under the federated large model adaptive learning system in two data sets is also significantly improved compared with the original model. According to the classification accuracy and recall in Table 2, the federated large model adaptive learning system is effective in two different data sets.

1. A federated large model adaptive learning system, which is mainly composed of a mini model adaptive update module, a BERT large model and mini model normalization module, a BERT large model adaptive update module and a system privacy protection module, wherein
(1) mini model adaptive update module
for the diffculty in interaction between BERT large models and mini models, the mini model adaptive update module is designed, considering three optimization directions of mini model accuracy, mini model forgetting rate and mini model error, the mini model adaptive update module establishes adaptive criteria through the above optimization directions:
1) mini model accuracy submodule:
from the perspective of universality, in the mini model adaptive update, the accuracy of the mini models will determine the universality of the BERT large models, therefore, a mini model accuracy submodule is proposed, expressed as follows:
$$max {C}_{m} = \frac{1}{m} {\sum }_{i = 1}^{m} {t}_{i}$$
wherein Cₘ represents the average accuracy value of the mini model after an m incremental stage, and tᵢ represents the accuracy value corresponding to an i stage,
2) mini model forgetting rate submodule:
from the perspective of functionality, in the mini model adaptive update, the mini model forgetting rate determines the convergence property of the mini models, and further determines the convergence of the BERT large models, therefore, a mini model forgetting rate submodule is designed, expressed as follows:
$$min F ( q ) = ud + ( 1 - u ) F ( q - 1 )$$
wherein F(q) represents the mini model forgetting rate of the mini model at time q; F(q) represents the mini model forgetting rate of the mini model at time q−1, u is a coefficient with a value range between [0,1], which is used to control a decay rate, and d is data at current time;
3) mini model error gradient submodule:
from the perspective of high efficiency, in the mini model adaptive update, the error gradient directly determines the effciency of the BERT models, therefore, a mini model error gradient submodule is designed, expressed as follows:
$$min w ( v ) = w ( v - 1 ) + η \times ∇ E ( v )$$
wherein w(v) represents the weight at time v, w(v−1) represents the weight at time v−1, η is a learning rate, and ∇E(v) represents the error gradient at time v;
(2) BERT large model and mini model normalization module
in the process of the mini model adaptive update, mini model gradient information is generated continuously; therefore, the BERT large model and mini model normalization module will realize normalization of the BERT large modules and the mini models in the gradient information to establish a basis for the implementation of the BERT large model adaptive update module; the gradient information has two properties of size and direction; the privacy protection principle of federated learning allows the mini models to transmit the gradient information to the BERT large models, and the gradient information generated by the mini models is used for feedback learning of the BERT large models; however, there is a huge difference in the number of parameters between the large BERT models and the mini models, and the gradient of the mini models cannot be directly used by the BERT large models; therefore; a method based on gradient scaling is proposed to assess the difference in the number of param,ters between the mini models and the BERT large models and priori knowledge, so as to establish the corresponding relationship between the gradient values of the mini models and the gradient values of the BERT large models; the gradient scaling method is expressed as follows:
$${T}_{grad}^{′} = {t}_{grad}^{′} ( \frac{{T}_{grad}}{2 {t}_{{grad}^{}}} + \frac{{T}_{n}}{2 {t}_{n}} )$$
wherein T_{grad}′ represents the corresponding gradient value of the mini models on the large models, t_{grad}′ represents the gradient value of the mini models, T_{grad} is the priori gradient value of the large models, t_{grad} is the priori gradient value of the mini models, Tₙ is the number of parameters of the large models, and Tₙ is the number of parameters of the mini models;
(3) BERT large model adaptive update module
in the BERT large model and mini model normalization module, the normalization of the mini model gradient information and the BERT large model gradient information is realized, the BERT
large model adaptive update module determines the gradient information normalization from two aspects of the generalization ability and gradient fitting to help the BERT large models for adaptive update;
1) generalization ability
in order to monitor the gap of the learning direction between the BERT large models and mini models, the consistency of collaborative learning directions between the BERT large models and mini models is maintained; through a distributed perception method, the local data is firstly used for measuring the deviation value of the large models preliminarily, and then making secondary measurement in combination with the online data at an edge server; therefore, a generalization assessment method is proposed for assisting the adaptive learning function of the federated adaptive learning system, expressed as follows:
$$f ( x , y ) = \frac{1}{( 1 + {e}^{- \vert g ( x , y ) \vert} )}$$
$$g ( x , y ) = \frac{α ( 2 {μ}_{x} {μ}_{y} + {δ}_{1} ) ( 2 {σ}_{x , y} + {δ}_{2} )}{( {μ}_{x}^{2} + {μ}_{y}^{2} + {δ}_{1} ) ( {σ}_{x}^{2} + {σ}_{y}^{2} + {δ}_{2} )} - λ$$
wherein ƒ(x, y) is called a generalization evaluation function, and g(x, y) is called a distributed perceived similarity function; x and y are the evaluation results of the large models and the mini models respectively; x and y are one-dimensional vectors, μₓ and μ_{y} are the average values of the two respectively; σₓ and σ_{y} are the variances of the two respectively, and σ_{x,y} are the covariances of the two; δₓ and δ_{y} are two minimal constants respectively, to prevent a denominator from being 0; α is a scaling factor with a value range of [10,20] to ensure that the range of ƒ(x, y) is between (0,1), and λ is a normalization constant which limits the range of the domain of definition,
through the generalization assessment method, the generalization ability is expressed as follows:
$$max {\sum }_{i = 0}^{n} {f}_{i} ( x , y ) \\ s . t . \frac{1}{n + 1} {\sum }_{k = 0}^{n} {\sum }_{j = 0}^{n} \vert {f}_{k} ( x , y ) - {f}_{j} ( x , y ) \vert \leq C$$
wherein fᵢ(x,y) is a generalization ability value in different tasks; n is the number of the tasks; C is a constant having a value between [0,1], and C constrains the differences in the assessment of the generalization ability among different tasks;
2) Gradient Fitting
because the BERT large model cannot obtain the latest data, starting from gradient information, the gradient of the BERT large model is fitted with the mini model as much as possible, to indirectly learn the features of the latest data; the gradient fitting is expressed as follows:
$$min {\sum }_{i = 0}^{S} \vert {T}_{i} - {t}_{i} \vert$$
wherein Tᵢ is the gradient value of the large model, tⱼ is the gradient value of the mini model, and S is the maximum number of training;
(4) System Privacy Protection Module
in the mini model adaptive update module, the BERT large model and mini model normalization module and the BERT large model adaptive update module, the federated adaptive learning system is applied to the BERT large model; the system privacy protection module is combined in the federated adaptive learning system, and the federated adaptive learning system is placed in a privacy protection mechanism; the system privacy protection module realizes the privacy protection of the federated adaptive learning system, comprising a noise adding mechanism and an approximate weight matrix average vale mechanism;
1) Noise Adding Mechanism
with respect to the characteristic that the interactive learning process of the BERT large models and mini models is private, the noise adding mechanism is proposed to hide the contribution of a single client in the aggregation by a method of adding after subsampling to hide in the entire distributed learning process; the specific implementation is as follows:
in random subsampling, the total number of clients is denoted as K; in each round of communication, a random subset Zₜ with a size T is extracted, and a subscript t represents the number of current rounds; then an administrator distributes a central model of the current round to each client; the central model of the current round is denoted as Wₜ; the data of the central model is optimized by a customer; each independent client in Zₜ has a different client model {W^{k}}ₖ₌₀^{T}; and Gaussian noise operation is added to each client:
$${\overline{W}}^{k} = {W}^{k} + N ( 0 , {σ}^{2} ) k ∈ [ 0 , T ]$$
wherein W̅^{k} is the client model after Gaussian noise is added, the noise follows N(0,σ²) distribution, and a standard deviation σ determines a noise scale; and a difference between the optimized client model W̅^{k} and the central model Wₜ is called the update of the client model and denoted as ΔW̅^{k};
at the end of each round of communication t, the update ΔW̅^{k} of the clients is transmitted back to the administrator of the central model;
2) Approximate Weight Matrix Average Vale Mechanism
with respect to the characteristic that the interactive learning process of the BERT large models and mini models is complicated, a method for approximating the average value of the weight matrix by distorting the sum of all updates by a Gaussian mechanism is proposed; the method uses the Gaussian mechanism to distort the sum of all the updates, and enhances certain operational sensitivity by using scaling versions instead of real updates; the specific implementation is as follows:
$$= / max ( 1 , \frac{{‖ Δ {\overline{W}}^{k} ‖}_{2}}{S} )$$
wherein ΔW̅^{k} represents the scaling of the update model after scaling, and S represents scaling sensitivity;
S is added to the sum of all scaling updates and then the output of the mixed noise mechanism is divided by T to obtain the real average value of the updates of all clients while preventing the disclosure of critical personal information; and the approximate value is added to Laplace noise and added to the current central model W to distribute a new central model:
$${W}_{t + 1} = {W}_{t} + \frac{1}{T} ( {\sum }_{k = 0}^{T} Δ {{W}^{=}}^{k} + {\sum }_{k = 0}^{T} Laplace ( \frac{Δ {\overline{W}}^{k}}{ε} ) )$$
wherein Laplace represents Laplace noise calculation and ε represents privacy budget.
